(19) United States
(12) Patent Application Publication
(10) Pub. No.: US 2013/0084062 A1
(43) Pub. Date: Apr. 4, 2013

(54) HITLESS PROTECTION FOR TRANSMITTING TRAFFIC IN HIGH-SPEED SWITCHING SYSTEM

(71) Applicants: Junquiang Hu, Davis, CA (US); Philip N. Ji, Cupertino, CA (US); Ting Wang, Cupertino, CA (US); Yoshiaki Aono, Cupertino, CA (US)

(72) Inventors: Junquiang Hu, Davis, CA (US); Philip N. Ji, Cupertino, CA (US); Ting Wang, Cupertino, CA (US); Yoshiaki Aono, Cupertino, CA (US)

(73) Assignee: NEC LABORATORIES AMERICA, INC., Princeton, NJ (US)

(21) Appl. No.: 13/543,541

(22) Filed: Jul. 6, 2012

Related U.S. Application Data
(60) Provisional application No. 61/540,606, filed on Sep. 29, 2011.

(51) Int. Cl. H04L 12/24; H04B 10/08

(52) U.S. Cl. 398/2; 370/218

(57) ABSTRACT

A system to provide hitless protection includes a primary line card with a synchronous interface, the primary line card processing traffic with cells and encapsulating the traffic into synchronous frames in a predetermined format; and a back-up line card with a synchronous interface, the back-up line card processing the traffic with the cells and encapsulating the traffic into the synchronous frames in the predetermined format, wherein each line card includes a buffer to align the traffic before transmission, wherein the cell information sent by the primary line card is passed to the back-up line card, and wherein the back-up line card follows the received information to send to the destination cell.

This application claims priority to Provisional Application Ser. No. 61/540,606 filed Sep. 29, 2011, the content of which is incorporated by reference.

Hitless protection relates to the ability of switching to protecting mode without losing frame and framing synchronization when failure occurs, to ensure that telecommunications equipment provide uninterrupted or continuous service and maintain an extremely high-reliability rating. This is achieved through 1+1 protection, in which the protecting module processes the inputs the same way as the working module, and the protecting link carries the same traffic as well; the receiver side or output multiplexer would pick the preferred one, either by configuration or by quality.

In synchronous communication system, for example optical transport network (OTN), hitless protection requires bit-level alignment between primary and backup interfaces, to keep receiver side synchronized when switching to backup one. Though this is mainly the physical layer device's responsibility, the data input to the physical layer device or to the framing point must be aligned as well to reduce the requirement to physical layer device. In cell or packet based switching systems, data arrived at different line cards from switch fabric may have different delay caused by either traffic manager or switch fabric scheduling.

FIG. 1 shows an examplary conventional system 100. System 100 has client line cards to provide client interface 118, for example line card 102 and 104; core interface line card with 1+1 protection to provide core link connection 116, for example line card 108 as primary and 110 as its backup; physical link switch 112 (further controlled by protection control signal 114) to connect core link 116 to either primary or backup core interface line card; and fabric card 106 for switching.

### SUMMARY

A system to provide hitless protection includes a primary line card with a synchronous interface, the primary line card processing traffic with cells and encapsulating the traffic into synchronous frames in a predetermined format; and a back-up line card with a synchronous interface, the back-up line card processing the traffic with the cells and encapsulating the traffic into the synchronous frames in the predetermined format, wherein each line card includes a buffer to align the traffic before transmission, wherein the cell information sent by the primary line card is passed to the back-up line card, and wherein the back-up line card follows the received information to send to the destination cell.

Advantages of the preferred embodiments may include one or more of the following. The system compensates for switching path delay, and aligns cells entering the framing module. The system provides a practical approach to achieve the required switching to protecting mode without losing frame and framing synchronization when failure occurs, to ensure that telecommunications equipment provide uninterrupted or continuous service and maintain an extremely high-reliability rating. It is ideal for application in high-speed systems such as systems operating at 100 Gb/s line rate or higher. The system uses a small amount of buffer, and requires reasonable capacity in synchronizing the primary and backup line cards.

### BRIEF DESCRIPTION OF THE DRAWINGS

FIG. 1 shows an exemplary conventional line card.

FIG. 2 Hitless protection for transmitting traffic in high-speed switching system

FIG. 3 shows an exemplary Flow Identification(ID) and Sequence Number at the end of a sample packet or cell.

FIG. 4 shows an exemplary Flow ID and Sequence Number in front of a sample data field.

FIG. 5 shows an exemplary frame format using one-bit to indicate TDM or packet traffic.

FIG. 6 shows an exemplary OPU3 tributary slot allocation.

FIG. 7 shows an exemplary cell mapping to OPU3 tributary slot 1, using 119 byte cell length

FIG. 8 shows an exemplary cell mapping to OPU3 tributary slot 1, using 64-byte cell length

FIG. 9 shows an exemplary timing for information exchange from primary to backup line card

FIG. 10 shows an exemplary buffer allocation scheme in OTN4 line card

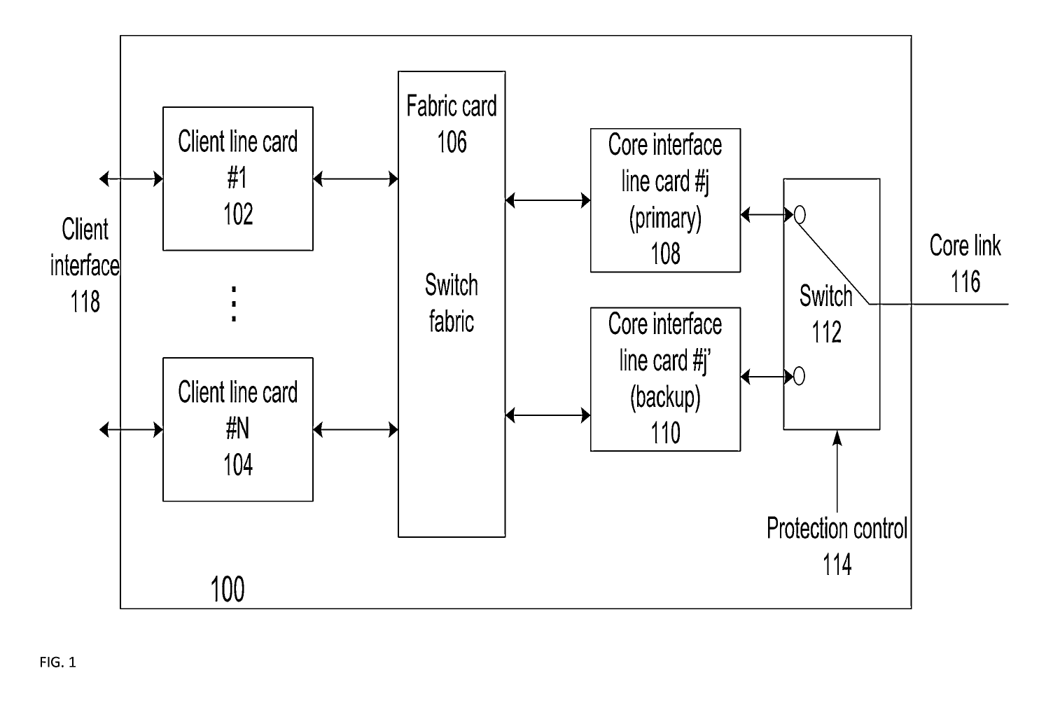

### DESCRIPTION

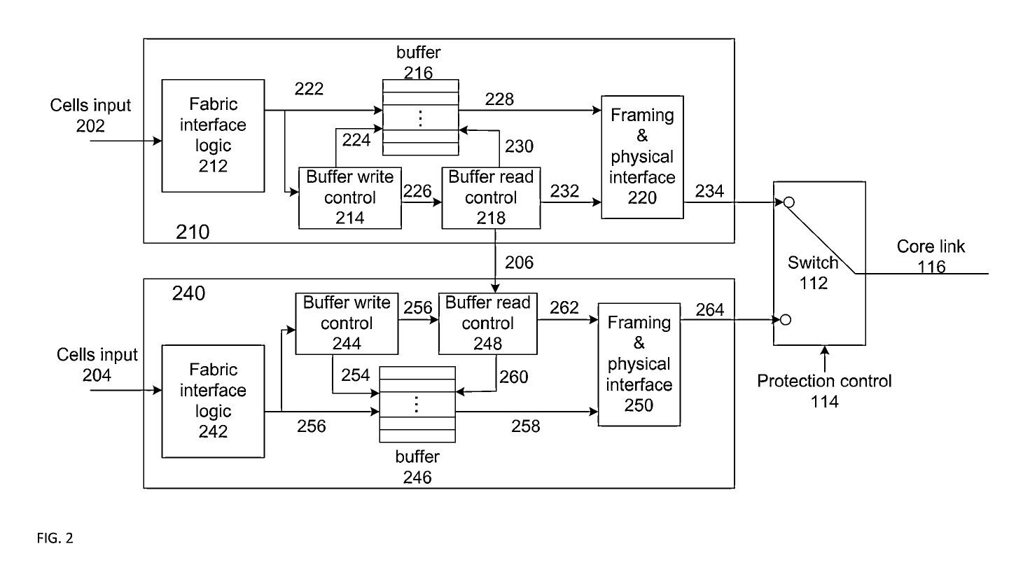

FIG. 2 is the block diagram describing the present invention. Line card 210 works as the primary one, while line card 240 works as backup. Each line card contains an aligning buffer, such as buffer 216 and 246, to compensate switching skew/jitter and align the cells sending to framing modules like 220 and 250. The data input to the buffer is controlled by buffer write control module (214 and 244), which extracts the cell information from the output of fabric interface logic (212 and 242) and generates write address/enable signals (224 and 254) to the buffer. Data outputs from 212 and 242 are also connected to buffers 216 and 246 as writing data. Buffer write control logic 214 and 244 has output connection 226 and 256 to buffer read control module 218 and 248, for queue status (or availability) indication. In primary line card 210, based on queue status or availability information from module 214, buffer read control module 218 generates read address to buffer 216, and notifies framing & physical interface module 220 through signal 232. When buffer read control module 218 in primary line card 210 is sending or about to send cell(s) to framing & physical interface module 250, it passes this information to backup line card 240 through signal 206. Buffer read control module 248 in backup line card 240 reads buffer according to this received information from primary line card 240, and notifies framing & physical interface module 250 for this availability. Both 220 and 250 outputs the framed signals (234 and 264) to switch 112, which is controlled by protection control signal 114, and further to core link 116.

The system adds a buffer in the line card to compensate for cell switching jitter and skews between primary and backup line cards. The buffer is accessed by cells sequence number. The primary line card delays read access from the time a cell is valid in the buffer, to compensate for the jitter and skew. The primary line card sends information about the cells sent in one frame to the backup line card to synchronize its sending with primary line card. A frame-synchronous sync signal is used to enable the sending of such information for the backup line card to know which frame the information is applied, and the information is sent several cycles later than sync signal, to avoid timing error or complicated timing adjustment in backup line card

The system adds sequence number and flow ID to the cells to be switched to the destination line cards. In the destination line card, the cells are buffered at address generated from its sequence number. The buffer size is enough to compensate for the jitter and skew between the primary and backup line cards.

For a certain flow, the cell valid signal is delayed for pre-defined cell cycles before triggering read action in primary line card. This is to compensate for the above mentioned jitter and skew. The primary line card delays the traffic transmission for several cell cycles to compensate for switching delay and jitter. When read started, the primary line card keeps on reading from that flow by incrementing the cell address, until a flow is released.

For each frame period the cells to be (or being) transmitted, the primary line card passes the cell information to backup line card. Such information can include sequence number, flow ID, and the mapping method etc. Backup line card transmits the cells with timing according to information received from primary line card.

Next, an exemplary embodiment that uses ODU switching in OTN line card is discussed as example. However, the system is not limited to the specifics therein, and the method can be applied to other line cards as well.

Cell format definition is discussed next. Usually the receiver processes the traffic in a flow-basis. The “flow” can be classified by traffic's originating port (i.e., source port), destination port, and other information like priority. In one embodiment, in ODU switching case, each ODU slot being switched is treated as one flow. Each flow is mapped to one queue (or virtual queue). To support finest switching granularity (i.e., ODU0 switching) in OTN4 line card, the total number of flows needs to be larger than 80 (ODU4 has 80 tributary slots or TS; ODU0 occupies one of these TS). In packet-based (or packet/TDM mixed) switching systems, the number of flows supported in one port can be as much as 32K, which is much larger than the maximum number of TDM (ODU) flows. This flow information can be used to identify a particular cell, with added timestamp (or sequence number). To simplify the processing in destination port, a per-flow sequence number is preferred for its continuity. The number of bits needed for this sequence number can be decided by the maximum number of cells to be buffered for each flow. In the TDM case, this number is usually small (depends on the switching jitter or skew, which is usually less than 100 cells), but in packet case, it may require to buffer as much as 10 ms, which is equivalent to around 2M (i.e., 22-bit) frames in case of 100 G line card and 64-byte frame size.

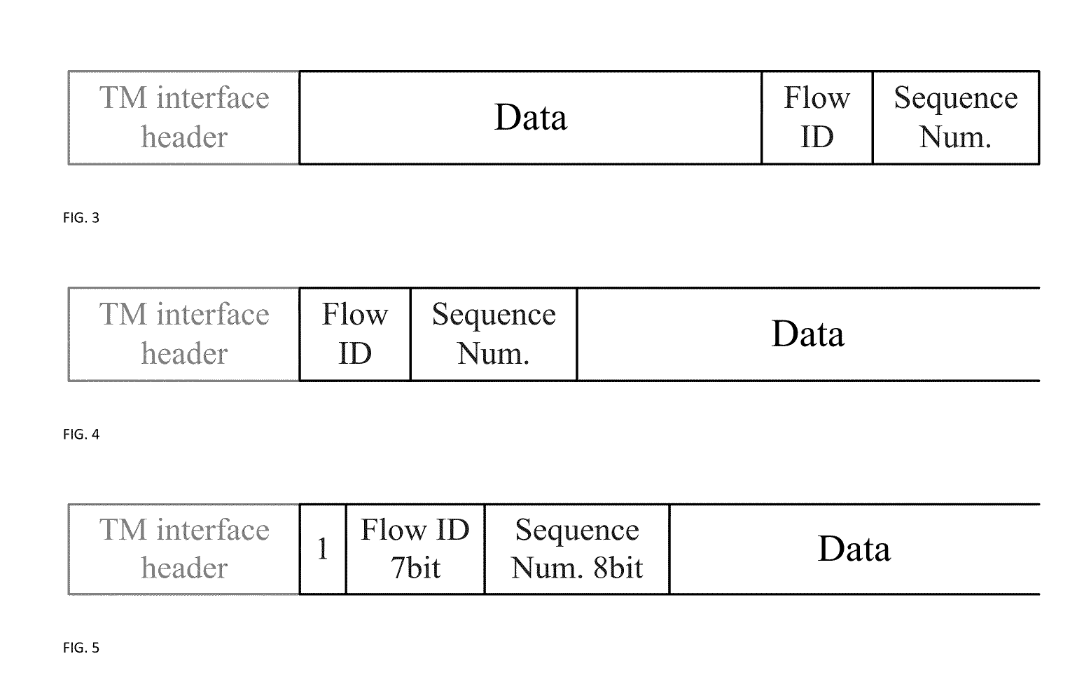

An embodiment of the present invention works with a unified cell format for TDM and packet traffic. To support 32K flows and 10 ms packet buffering as analyzed above, 15-bit flow ID and 22-bit sequence number can be defined for each cell. In one embodiment, to reduce the switching overhead, multiple flows that sharing the same policy (e.g., share the same aggregated bandwidth or have the same priority) can be aggregated. In case hitless protection is integrated with traffic management module, in one embodiment, the flow ID can be the same field as in switching header. Table 1 is an example header format for fabric interface (prior art), where “flow” can be the combination of TRAFFIC_CLASS, SRC_SYS_PORT, and OUT_FAP_PORT. In application that traffic management device does not support hitless protection, and the interface to that device does not include flow information, additional field will be needed in packets/cells entering the traffic manger, for both flow ID and sequence number. In one embodiment, this additional field is attached to the end of a packet/cell, such as in FIG. 3; in another embodiment, this field is attached in front of the packet and behind the interface header, such as the example in FIG. 4.

| Field | Size | Bit/s | Meaning |
|---|---|---|---|
| Version | 2 | 47:46 | Fabric Header Version |
| PACKET_SIZE | 14 | 45:32 | Size in bytes |
| TRAFFIC_CLASS | 3 | 31:29 | Class of service |
| SRC_SYS_PORT | 13 | 28:16 | Identify the system-level source port |
| | | | or physical port |
| OUT_FAP_PORT | 8 | 15:8 | Outgoing fabric-access-processor |
| | | | (FAP) port of the destination device |
| DP | 2 | 7:6 | Drop Precedence |
| RSVD | 4 | 5:2 | Reserved |
| EXCLUCE_SRC | 1 | 1 | Indicate whether to filter packet at |
| | | | the egress, if source system port is |
| | | | the same as destination system port |
| SYS_MC | 1 | 0 | Packet is system multicast |

Usually the TDM cell size is 64-byte, so the additional overhead for flow ID and sequence number will be relatively large, if using same format as in packet mode. One embodiment of the present invention is to differentiate TDM and packet traffic, by using one bit as TYPE_INDICATION (for example, ‘0’ for packet and ‘1’ for TDM) and then defining the number of bits needed respectively. Consider that the flow ID is used in the destination port only, in one embodiment, it is allocated per line card without giving source and destination port number. For example, consider a system containing 4 ODU0 line cards, numbered from line card #0 to #3, each providing 20 ODU0 channels, and one OTN4 line card (numbered line card #4) to aggregate traffic from the 4 ODU0 line cards. For traffic switched to line card #4, the system may allocate flow ID 0 to 19 for those from line card #0, flow ID 20 to 39 for those from line card #1, and so on. With this approach, FIG. 5 gives an example frame format for TDM traffic, where only 2 bytes are needed.

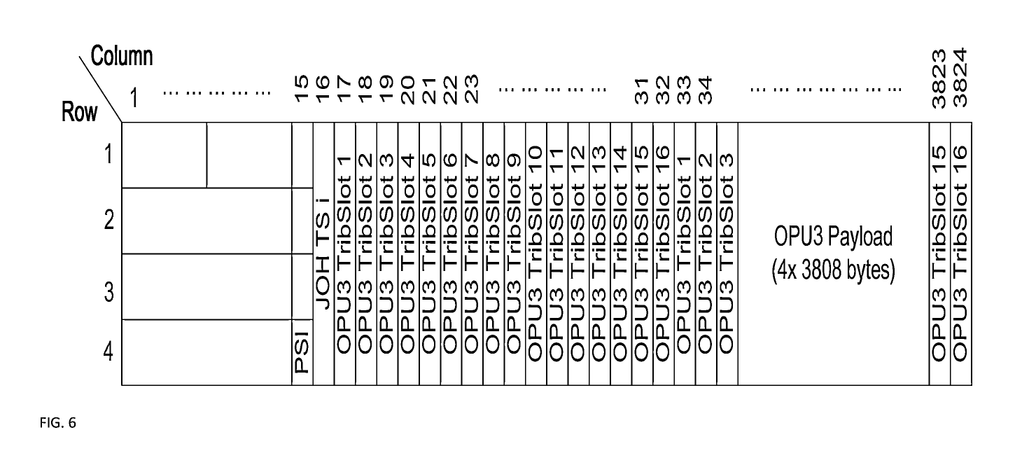

The system can also work with the OTN frame format. In OTN, each frame has fixed length, and the bandwidth is organized by tributary slot (TS). Each OTN frame has multiple TS interleaved to support ODU multiplexing. The TS can be either 1.25 Gb/s or 2.5 Gb/s. For example, ODU4 has 80×1.25 Gb/s TS, which can support 80× ODU0 or 40× ODU1 or 10× ODU2; ODU3 has 32×1.25 Gb/s TS, which can support 32× ODU0 or 16× ODU1 or 4× ODU2, or 16×2.5 Gb/s TS to support 16× ODU1 or 4× ODU2. FIG. 6 is the example tributary slot allocation for OPU3 using 2.5 Gb/s rate, in which each tributary slot has 238×4=952 bytes for one frame. OTN frame is organized by 4 rows×4080 columns. Columns 1˜16 in FIG. 6 are OTN frame and ODU overhead fields. PSI is payload structure identifier, which includes payload type; JOH TSi is justification overhead for tributary slot i. Columns 17˜3824 are for OPU3 field, which is divided into 16×2.5 G tributary slots, such as tributary slot 1 (column 17, 33, . . . ) and tributary slot 2 (column 18, 34, . . . ), and these tributary slots are interleaved. FIG. 6 shows such an exemplary OPU3 tributary slot allocation.

Next, operations needed to support 1+1 protection in transmitting traffic are described. In 1+1 protecting case, both the primary and backup line cards actively accept traffic from same source ports. Preferably, the system aligns the cells with same sequence number and flow ID into the same transmitting position. Here “position” means the frame number and the mapping inside the payload.

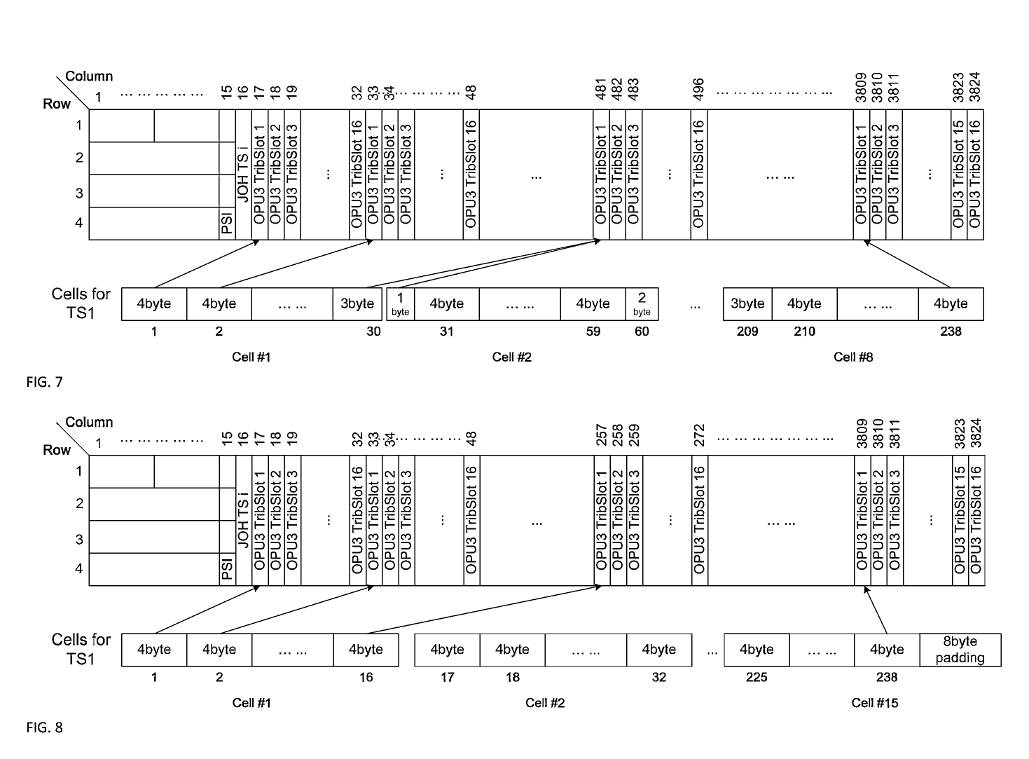

To align the data transmitted in the primary and backup line cards, one embodiment of the present invention organizes the switched cells on OTN frame and TS basis. With the example in FIG. 6, the cell size can be 952-byte, or 476-byte, or other fractional number. FIG. 7 is the illustration using 119-byte cell size for 2.5 Gb/s OPU3 tributary slot, in which the bottom are the cells to be mapped into tributary slot 1. Each frame can accommodate 8 cells. The first 4 bytes in cell #1 are mapped to column 17, second 4 bytes are mapped to column 33, and so on. The last 3 bytes in cell #1 plus the first byte in cell #2 are mapped to tributary slot of column 481; then bytes 2˜5 of cell #2 are mapped to column 497. One embodiment is to have cell length of other arbitrary (fixed) length L, plus the remaining bytes R (R<L), in which (n*L+R) (n=1,2, . . . ) equals to the total bytes of one TS in an OTN frame. For example, one TS in an OPU3 frame can be divided into 14×64-byte cells plus one 56-byte cell. FIG. 8 illustrates this example, with bottom part for the cells to be mapped into tributary slot 1, where the first 4 bytes of cell #1 are mapped to column 17, second 4 bytes of cell #1 are mapped to column 33, . . . , first 4 bytes of cell #2 mapped to column 273, and so on. The last 8 bytes in cell #15 are for padding only and are not mapped into any slots. In system that supports only fixed-size cell switching, for the latter case, the last cell in one frame can be padded to L, and the padding field be removed before mapping into OTN frame.

FIG. 7 illustrates an exemplary cell mapping to OPU3 tributary slot 1, using 119-byte cell length, while FIG. 8 illustrates corresponding cell mapping to OPU3 tributary slot 1, using 64-byte cell length. With cells format and mapping method defined above, the primary line card passes the cell number of each flow to the backup line card, for the cells being transmitted in current frame or to be transmitted in next frame. Optionally MFAS (MultiFrame Alignment Signal) or OMFI (OPU Multi-Frame Identifier, for OPU4 only) information is also exchanged from primary to backup line card, to identify the mapping of a cell in particular. In one embodiment, such information is sent once every frame; in other embodiments, it is sent once for each cell, or once every several frames. This information is received within the same frame as in the primary line card. A “sync” signal that is synchronous to frame_start is used for this synchronization. To tolerant the skew caused by PCB trace and device I/O delay, the primary line card leaves one or several free cycles after an active sync pulse and before the next active sync pulse. Each flow may have its own signals for this information exchange, or all the flows can share the same signals group.

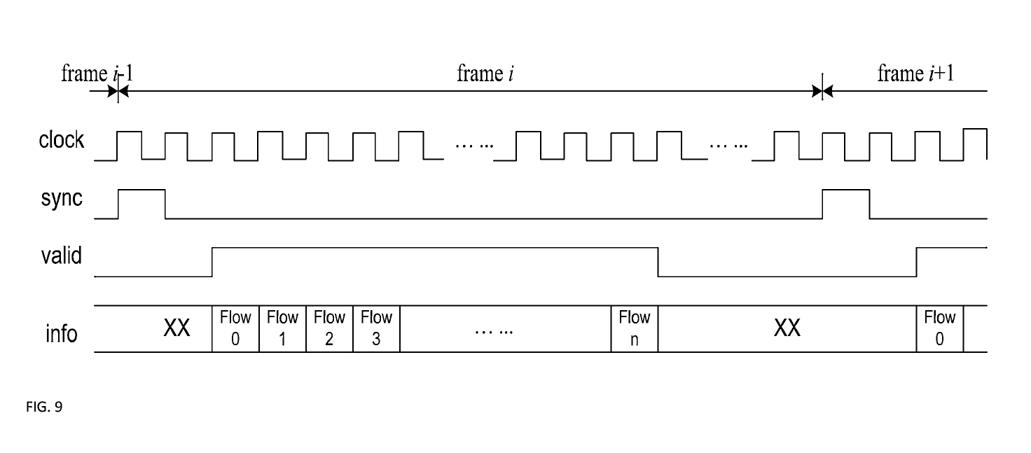

FIG. 9 shows an example implementation with same signal group for all the flows, using the cell format defined in FIG. 5, and exchanging information for each flow once every frame. In this examplary timing of information exchange from primary to backup linecard, a signal group “info[k-1:0]” contains the information to be exchanged, and a “valid” signal (active high) to indicate valid information carried by “info”. Two clock cycles after “sync” pulse are intentionally reserved for the possible skew in detecting the “sync” input inside the two line cards. The flow ID can be extracted from its corresponding pre-defined slot, for example, the information passed in the first valid cycle is for flow_ID=0, second is for flow_ID=1, and so on. For OTN4 line card supporting 80 ODU0 flows, the total bits to be passed in one frame time is 80*8=640, where 8 is the number of bits used for sequence number (see FIG. 5). Because OTN4 frame period is 1.168 us, the bandwidth needed for such information is 640/1.168 Mb/s which is roughly 548 Mbit/s.

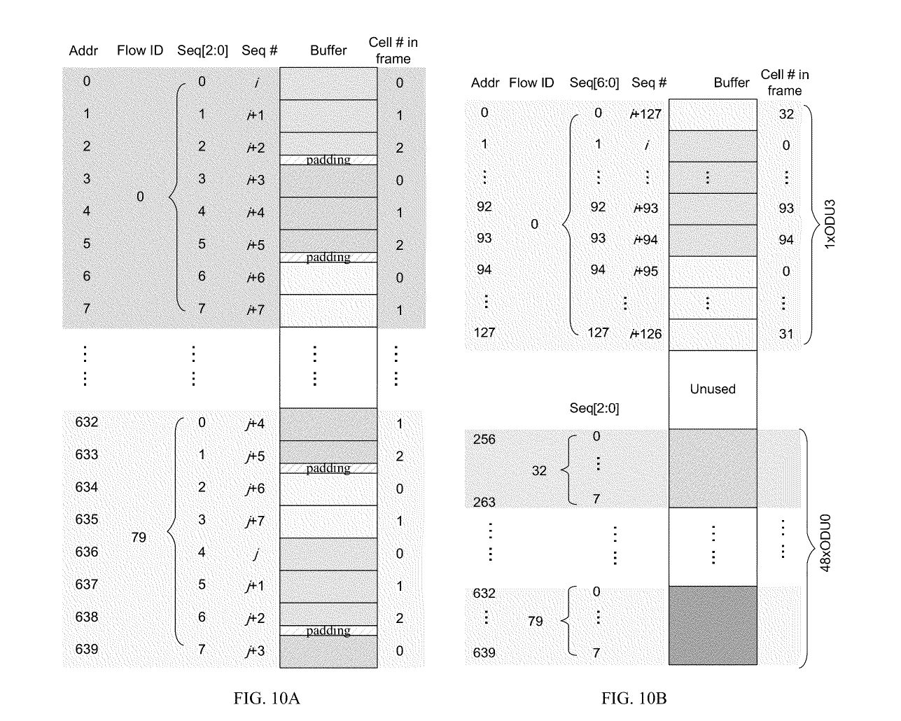

Similar to FIG. 2, a buffer is provided in each line card to compensate cell arrival jitter and the skew between the primary and backup line cards. A cell also needs to be buffered to wait for its corresponding slot in a frame, which is caused by the independent timing of switching module and framer. For example, the first cell in one frame might be received the cycle after its allocated slot. This means the buffer should be no less than one frame period plus the jitter and skew to compensate. To simplify the buffer access, in one embodiment, the size for each queue can be 2̂n cells (n=1, 2, . . . ). Each cell can be accessed through the corresponding flow ID and last several digits of sequence number. The buffer can be dynamically allocated for different ODU switching granularities. FIG. 10 gives example implementations to support OTN4 line card, cell size of 64-byte (not considering overhead which is needed in practical case), with maximum cell arrival jitter and skew of 4 cells.

FIG. 10A is for configuration of 80 ODU0 flows, while FIG. 10B for configuration of one ODU3 (using 32 tributary slots) and 48 ODU0 flows. In FIG. 10A, each flow in one frame contains 3 cells. Consider each frame of 190 bytes, then the 3rd cell has 2 padding bytes. The flow ID can be its corresponding TS, and the lowest 3-bit of sequence number are used to access the particular cell. The given address is the segment address for each cell. The actual buffer access address is composed of {7 bit FLOW_ID, 3 bit SEQ_LSB, 6 bit BYTE_OFFSET}. In FIG. 10B, flow ID 0 is allocated for ODU3, occupying 128-cell, and flow ID 32 to 79 are allocated for ODU0, each occupying 8 cells. The organization for the ODU0 flows is the same as FIG. 10(a). The ODU3 access address can be composed of {'b000, 7 bit SEQ_LSB, 6 bit BYTE_OFFSET}; ODU0 address can be composed of {7 bit FLOW_ID, 3 bit SEQ_LSB, 6 bit BYTE_OFFSET}. Note that the data width in these figures is one byte, which in practical implementation will be multiple bytes for desired throughput. Instead of using the corresponding TS as flow ID, the mapping from flow ID to tributary slot(s) may also use another table.

The cells size selection methods in the above embodiments may have some constraint or require additional padding for the last cell. For example, with tributary slot allocation in FIG. 6, the system may use cell size of 119-byte, which might not be optimum for internal switching. Another embodiment is to organize the switched cells independent of the OTN frame, such as 64-byte. Besides the cell sequence number to be exchanged as in the previous solution, the particular byte mapping information is also needed. One approach is to give the cell sequence number and byte position which is mapped to the first byte of the corresponding TS in one frame. Alternatively, it may give the mapping of the first byte in a cell to the position in the OTN frame.

The foregoing detailed description is to be understood as being in every respect illustrative and exemplary, but not restrictive, and the scope of the invention disclosed herein is not to be determined from the description of the invention, but rather from the claims as interpreted according to the full breadth permitted by the patent laws. It is to be understood that the embodiments shown and described herein are only illustrative of the principles of the present invention and that various modifications may be implemented by those skilled in the art without departing from the scope and spirit of the invention.

What is claimed is:

1. A system, comprising:
a primary line card with a synchronous interface, the primary line card processing traffic with cells and encapsulating the traffic into synchronous frames in a predetermined format; and
a back-up line card with a synchronous interface, the back-up line card processing the traffic with the cells and encapsulating the traffic into the synchronous frames in the predetermined format, wherein each line card includes a buffer to align the traffic before transmission, wherein the cell information sent by the primary line card is passed to the back-up line card, and wherein the back-up line card follows the received information to send to the destination cell.

2. The system of claim 1, wherein each cell comprises an independent frame.

3. The system of claim 2, wherein the cell information comprises cell-to-frame mapping.

4. The system of claim 1, wherein the cells are segmented by frame.

5. The system of claim 4, wherein a cell size is a fraction of a frame size.

6. The system of claim 4, wherein a cell size is larger than a frame size and wherein an end cell includes padding bytes.

7. The system of claim 1, wherein each cell received by the line cards include a sequence number.

8. The system of claim 7, comprising an alignment buffer is organized by the sequence number.

9. The system of claim 7, wherein the sequence number is allocated for each flow.

10. The system of claim 7, wherein information from the primary line card to the back-up line card includes a sequence number.

11. The system of claim 1, wherein information from the primary line card to the back-up line card includes flow identification.

12. The system of claim 11, wherein the traffic comprises an Optical Transport Network (OTN) where one flow comprises an Optical channel Data Unit (ODU) slot.

13. The system of claim 11, wherein information for each flow is transmitted through dedicated signal(s).

14. The system of claim 11, wherein signals from the primary line card to the back-up line card are shared among different flows.

15. The system of claim 1, wherein information from the primary line card to the back-up line card is passed to the back-up line card in each frame.

16. The system of claim 15, wherein information is transmitted based on a cycle from a sync signal or is transmitted once every predetermined frame cycles.

17. The system of claim 15, wherein information transmission is delayed for a plurality of cycles after a sync signal.

18. The system of claim 1, comprising a sync signal synchronous to a frame start used by both line cards.

19. The system of claim 18, wherein information is transmitted based on a cycle from the sync signal or is transmitted once every predetermined frame cycles.

20. The system of claim 18, wherein information transmission is delayed for a plurality of cycles after a sync signal.

21. The system of claim 1, wherein the primary line card delays the traffic transmission for a plurality of cell cycles to compensate for switching delay and jitter.

22. The system of claim 1, wherein the synchronous interface comprises an optical transport network.

23. The system of claim 1, wherein the frames are sent using time-division multiplexing (TDM) or packet switching.

24. The system of claim 23, wherein the cell includes a sequence number and a flow identification with different length for TDM and packet switching.

25. The system of claim 23, wherein the cell includes a sequence number and a flow identification with different length for TDM and packet switching.

26. The system of claim 1, comprising a frame-synchronous sync signal to enable sending of cell information for the backup line card to apply the information to a predetermined frame.
